(19) United States
(12) Patent Application Publication
(10) Pub. No.: US 2018/0035641 A1
(43) Pub. Date: Feb. 8, 2018

(54) Portable Hand-Held Devices for Cleaning an Animal's Paw and Related Methods Thereof

(71) Applicant: Pet Product Innovations, LLC, Des Plaines, IL (US)

(72) Inventors: David Levy, Des Plaines, IL (US); Joseph Ek, Des Plaines, IL (US)

(73) Assignee: Pet Product Innovations, LLC, Des Plaines, IL (US)

(21) Appl. No.: 15/435,995

(22) Filed: Feb. 17, 2017

Related U.S. Application Data
(63) Continuation of application No. PCT/US2015/045813, filed on Aug. 19, 2015.
(60) Provisional application No. 62/039,181, filed on Aug. 19, 2014.

(51) Int. Cl. A01K 13/00

(52) U.S. Cl. CPC A01K 13/001; A61D 11/00

(57) ABSTRACT

Devices for cleaning an animal's paw and related methods are described herein. Devices include a container having a handle and an opening area adapted to receive the paw. A flexible insertion piece substantially covers the opening area, and a trigger mechanism is connected to the handle. Devices also include an inner container having a plurality of cleaning elements extending radially inward therefrom. Rotation of the inner container to clean the animal's paw is effectuated by engaging the trigger mechanism.

This application is a continuation application of International Application No. PCT/US2015/045813, filed on Aug. 19, 2015, which claims the benefit of U.S. Patent Application No. 62/039,181, filed on Aug. 19, 2014, which are hereby both incorporated by reference.

### I. FIELD OF THE INVENTION

The present disclosure generally relates to portable hand-held devices for cleaning an animal's paw, and related methods thereof. More specifically, devices of the present disclosure include a cleaning mechanism capable of rotational movement in varying directions relative to the outer surface of an animal's paw when the device is in use.

### II. BACKGROUND

Grooming and maintaining overall cleanliness is one of an animal's basic needs and, as a result, an important aspect with regard to caring for an animal. Similar to humans, animals including farm animals and pets require ongoing physical care and maintenance to, inter alia, maintain a healthy body; prevent and/or treat injuries, illness and disease; minimize and/or remove the presence of foreign substances; and to look and feel their best.

It is especially important to be able to thoroughly and effectively clean the paws of an animal for any one of the reasons highlighted above including others. For example, on a regular basis it is not uncommon for the paws of an animal to come into direct contact with any one of: allergens, germs, chemicals, irritants, dirt, insects, feces, parasites, ticks, and/or fleas. Therefore, it is important to regularly clean the paws of an animal to remove such substances. In addition, many animals sweat or perspire through their paws, thereby creating a suitable environment for germs and bacteria to grow. Moreover, depending on the circumstances, breed, size, species, and/or type of animal, many animals have paws which can be prone to cracking, cuts, blisters, and/or otherwise irritated unless properly cleaned on a regular basis.

However animals, especially pets, generally do not enjoy having an owner or caretaker clean their paws. Many animals and pets are nervous and simply do not like being around or in contact with water, including cleaning agents. As such, although important and often times necessary, cleaning an animal's paws can be a difficult and onerous task for many.

Another frequently encountered problem with cleaning an animal's paws is related to the fact that animal paws have several varying contours, ridges, nooks and crannies, which further differ based on the animal type and breed. Typically only a carefully skilled veterinarian or trained animal care professional can attempt to remedy these difficulties. However, even trained professionals cannot offer fail-safe results in cleaning the paws of animals as they are subject to human error. Therefore, although methods currently exist in the art for cleaning an animal's paws (e.g., using a washcloth, soaking the paw in a water bath, using a brush or a sponge), such known methods are deficient and do not address the aforementioned difficulties and problems that remain in the art.

One example of known devices and methods in the art can be found in U.S. Pat. No. 7,302,915 to Leary et al., incorporated herein by reference in its entirety and commonly owned with the present application. U.S. Pat. No. 7,302,915 describes a portable device for cleaning an animal's paw, having a container adapted to receive a cleaning agent. The container includes a cleaning platform, with at least one scrubbing element attached to the interior surface of the cleaning platform. Although the device of U.S. Pat. No. 7,302,915 allows for an animal's paw to be inserted into the device and manually scrubbed or cleaned therein, there remains a need for devices and methods capable of addressing the varying contours, paw shapes, ridges, nooks, etc. of animals of differing size, shape, species, and/or type.

In view of the foregoing, a need exists for innovative devices and methods for cleaning an animal's paws which overcome the above challenges and difficulties, many of which are innate in an animal's behavior (e.g., strong resistance to paw cleaning) and anatomy (e.g., varying contours and shape outline of an animal's paws). It would be beneficial to have devices and methods for cleaning an animal's paws capable of achieving optimum results for thoroughly yet gently cleaning an animal's paws, in addition to devices and methods capable of adapting to the changing contours of an animal's paws, whether by type, breed, species, or size. It would also be desirable to have devices and methods that do not demand specialized abilities or skills to clean an animal's paws.

Embodiments of the present invention address these and other needs by providing portable, hand-held devices for cleaning an animal's paw. Devices of the present invention are configured to engage in rotational movement such that portions of the device having cleaning elements or scrubbing elements attached thereto (e.g., brushes, pads, bristles, etc.) rotationally move about the paw of the animal when the paw is inserted into the device. The rotational movement is not particularly limited and can, for example, be in clockwise/counterclockwise directions and vertical directions, among others.

### III. SUMMARY

At least one embodiment of the present invention includes a device for cleaning an animal's paw. The device includes a container having a handle and an opening adapted for receiving the animal's paw. A flexible insertion piece or squeegee member is provided which substantially covers the opening. The flexible insertion piece or squeegee member includes a plurality of radially recessed portions recessed in a direction of insertion of the paw. The device further includes a trigger mechanism hingeably connected to the handle and a substantially cylindrical inner container or cleaning platform. The inner container includes a plurality of through holes and a plurality of cleaning elements or scrubbing elements extending radially inward from an inner wall of the inner container. The inner container also includes a base, whereby the base of the inner container is in operable communication with a rotational axle. The rotational axle is also in operable communication with the trigger mechanism such that depression of the trigger mechanism effects rotational movement of the inner container.

At least one embodiment of the present invention includes a device for cleaning an animal's paw. The device includes a container having a handle and an opening area adapted for receiving the animal's paw. A flexible insertion piece or squeegee member is provided which substantially covers the opening area. The flexible insertion piece includes a plurality of radially recessed portions recessed in a direction insertion of the paw. The device further includes an actuating mechanism connected to and in operable communication with the device, and a substantially cylindrical inner container or cleaning platform. The inner container or cleaning platform includes a plurality of through holes, a plurality of cleaning elements or scrubbing elements extending radially inward from an inner wall of the inner container, and a base. The base of the inner container is operably connected to a rotational axle. The rotational axle is in operable communication with the actuating mechanism such that engagement of the actuating mechanism effects rotational movement of the inner container.

### IV. BRIEF DESCRIPTION OF THE SEVERAL VIEWS OF THE DRAWINGS

The present disclosure may be better understood, and its numerous features and advantages made apparent to those skilled in the art by referencing the accompanying drawings.

FIG. 1 is an illustration of a device according to at least one embodiment of the present invention.

FIG. 2 is an illustration of portions of a device according to at least one embodiment of the present invention.

FIG. 3 is an illustration of a bottom view of portions of a device according to at least one embodiment of the present invention.

FIG. 4 is an illustration of a cross-sectional cutaway view of portions of a device according to at least one embodiment of the present invention.

FIG. 5 is an illustration of a cross-sectional cutaway view of portions of a device according to at least one embodiment of the present invention.

FIG. 6 is an illustration of a cutaway view of portions of a device according to at least one embodiment of the present invention.

FIG. 7 is an illustration of a cutaway view of portions of a device according to at least one embodiment of the present invention.

FIG. 8 is an illustration of a cutaway view of portions of a device according to at least one embodiment of the present invention.

FIG. 9 depicts a brush inserted into a through hall of the wall of the inner container in accordance with the invention.

### V. DETAILED DESCRIPTION

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In this detailed description, references to “one embodiment”, “an embodiment”, or “in embodiments” mean that the feature being referred to is included in at least one embodiment of the invention. Moreover, separate references to “one embodiment”, “an embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Grooming, such as cleaning an animal's paws, is one of the most important aspects of animal and pet care. Aside from an animal's paws coming into contact with any number of foreign and/or hazardous substances, many animals and pets have specific concerns which make regular and consistent paw cleaning a necessity for animal and pet owners and caretakers.

For example, in the case of a dog's paws, it is not uncommon for dogs to have yeast on their paws, especially in warmer climates and during hot summer months. Yeast growth can generate an itching sensation for a dog on its paws, which in turn can cause a dog to excessively groom, lick, and/or chew its paws in constant discomfort. One way to treat and/or prevent this from happening is to clean and wash the paws regularly (and sometimes even daily), with or without a pet friendly shampoo.

In the winter months, many animals and pets can come into contact with de-icing salt, which can be found all over sidewalks and streets. Even in the case of indoor animals, traces of de-icing salt can be brought in from the shoes of owners after they return from being outside. Repeated contact with de-icing salt can irritate an animal's paws and cause the paws to become dry and crack. One way to treat and/or prevent this from happening is to clean and wash the paws regularly (and sometimes even daily) to remove salt residue and moisturize the paws.

Accordingly, it is generally settled that cleaning an animal's paws with some regular frequency is an important and integral piece toward the ongoing care and well-being of the animal or pet. Nevertheless, benefits of cleaning an animal's paws cannot be generally accomplished or achieved by devices and methods known in the art.

For instance, one known method for cleaning an animal's paws is to soak or submerge the paws in a tub of water or soapy water. Although the submersion method may overcome challenges in making sure every contour and groove of an animal's paw is reached, this method is not practical for the majority of animals and pets. More specifically, most animals and pets do not enjoy or easily allow one to clean its paws, and typically will not allow any cleaning to happen without first offering up some strong resistance. Therefore, only a carefully skilled and trained professional can be successful in employing this method for cleaning an animal's paws. Similar challenges apply when using a brush, a wash cloth or a sponge to clean an animal's paws.

Accordingly, embodiments of the present invention address and alleviate the above challenges by providing portable, hand-held devices that are configured to allow for rotational movement of cleaning elements or scrubbing elements while the paw of the animal is inserted into the device.

Various embodiments of the present disclosure will now be described, by way of example only, with reference to the accompanying drawings. It will be appreciated that the same reference numerals are used for components in one figure of the accompanying drawings which are substantially similar to components present in another figure of the accompanying drawings. However, use of identical reference numerals should not be understood that components which share identical reference numerals are necessary identical and should not be understood to limit said components in any way.

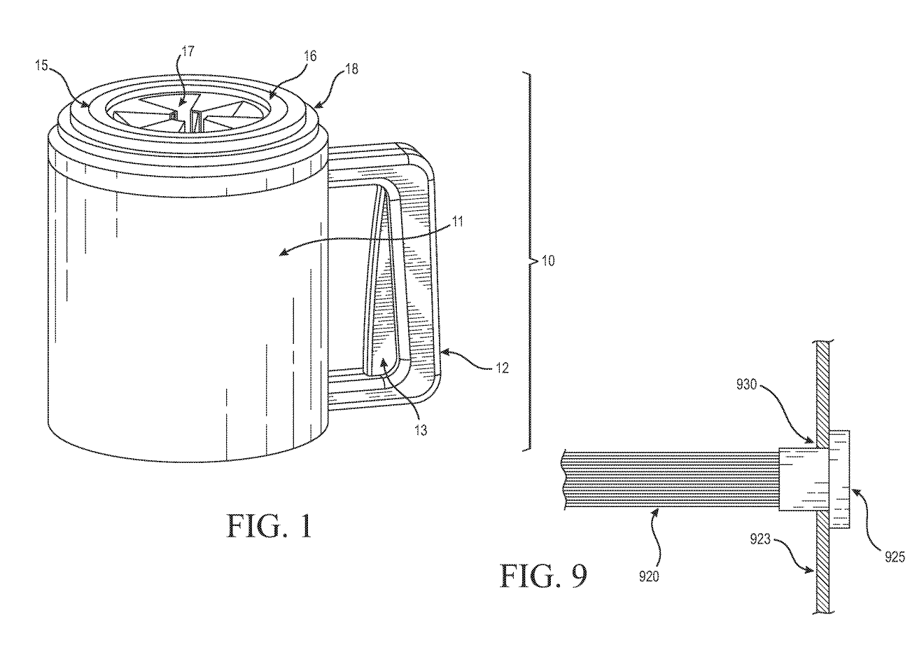

With reference to FIG. 1, a device 10 according to at least one embodiment of the present invention is illustrated therein. The device 10 can be hand-held and portable, allowing it to be easily transported to local and remote locations as needed or desired by the user. The device 10 can include a container 11. The container 11 can be substantially cylindrical in shape. Alternatively, in at least some embodiments, the container 11 can be angular in shape, polygonal, and longitudinally rectangular or squared or any other suitable shape.

In at least one embodiment, the container 11 can include a handle 12 and an opening area 15 adapted for receiving a paw of an animal. Regarding the handle 12, in at least one embodiment, the handle 12 can include a gripping portion (not illustrated). In certain embodiments, the handle 12 can be ergonomically configured to have any number of curvature(s) located along a length of the handle.

### The Flexible Insertion Piece

Regarding the opening area 15 adapted for receiving the paw of an animal, in at least one embodiment, a flexible insertion piece or a squeegee member 16 can be provided. The flexible insertion piece or squeegee member 16 can be configured to substantially cover the opening area 15, as shown in FIG. 1.

In at least one embodiment, the flexible insertion piece or squeegee member 16 can include a plurality of radially recessed portions 17 recessed in a direction of insertion of the paw. More specifically, during use, the paw of an animal enters the device 10 at the opening area 15, passing through the flexible insertion piece or squeegee member 16. The plurality of radially recessed portions 17 recessed in the direction of paw insertion facilitate entry of the paw into the device 10.

In addition, the plurality of radially recessed portions 17 of the flexible insertion piece 16, together, can serve to provide an opening that is: (1) sufficiently wide or large enough in size to fit the paw of an animal, and yet (2) restricted or limited enough in size such that the paw of the animal cannot easily exit the device 10, and any cleaning fluid or cleaning agent added to device 10 can remain substantially within the device 10. Moreover, the plurality of radially recessed portions 17 can also operate to provide a substantially funnel-like entry for the animal's paw.

In at least one embodiment of the present invention, the flexible insertion piece 16 can be a one piece material having a plurality of accordion folds thereon, and a girdle attached to the flexible insertion piece.

It will be appreciated that the opening area 15 and the flexible insertion piece or squeegee member 16 in devices 10 of the present invention can be adapted to accommodate different sizes, species, and/or types of animals, including farm animals and pets, and to accommodate specific needs of the user and the subject animal(s). In at least one embodiment, the flexible insertion piece 16 can be removable (e.g., for cleaning purposes), and can be replaceable to change the overall size of the opening for the animal's paw with differently sized flexible insertion pieces 16.

In at least one embodiment of the present invention, the flexible insertion piece 16 can be removably attached to a rim portion or an upper lip 18. In at least one embodiment of the present invention, the rim portion or upper lip 18 can be removably attachable to the main body of the container 11, as shown in FIG. 1. In at least one embodiment, the rim portion or upper lip 18 can be permanently affixed or attached to the container 11.

As shown in FIG. 1, in at least one embodiment of the present invention, the rim portion or upper lip 18 can include a series of step-like ridges, or steps, narrowing in an upward direction toward the opening area 15 of the device 10. Alternatively, the rim portion 18 can be a single rim or circular ring traveling around a perimeter of the container 11.

In at least one embodiment, the flexible insertion piece 16 can be permanently affixed or attached to the container 11, such as to the rim portion 18, in devices 10 where a rim portion 18 is present.

In terms of material, the flexible insertion piece 16 can be made of any strong, flexible, resilient, non-reactive, durable and non-toxic rubber or plastic material, such as natural and synthetic rubbers or a blend of synthetic rubbers, nylons, polyesters, and vinyl plastics. In embodiments, illustrative examples of suitable materials the first and second portions can be made of include, but are not limited to, neoprene plastic, isoprene, styrene-butadiene rubber, butadiene, ethylene-propylene, butyl, chloroprene, nitrile rubber and mixtures thereof.

### The Handle

Referring back to the handle 12 of the device 10, although the embodiment of FIG. 1 illustrates the handle 12 connected to a side of the device 12, with the gripping portion of the handle 12 substantially coaxial with the container 11, it will be appreciated that in alternate embodiments of the present invention, the gripping portion of the handle 12 can be substantially perpendicular to the longitudinal axis of the container 11. The handle 12 can also be of varying lengths. In particular, although the handle 12 of FIG. 1 has a length which substantially corresponds to the length of the main body of the container 11, in some embodiments a shorter length handle is employed.

Moreover, in cases where it is desired, devices of the present invention can include more than one handle connected to the device at various locations and in various configurations. It will be appreciated that in cases where more than one handle is present in the device, each of the multiple handles can share features described herein with respect to one handle, such as the handle 12 of the device 10 of FIG. 1.

In at least one embodiment of the present invention having multiple handles, the handles can be of a shorter length than the overall length of the container, and be aligned consecutively along a length of the container. Alternatively, the handles can be positioned at different locations across the outer surface area of the device.

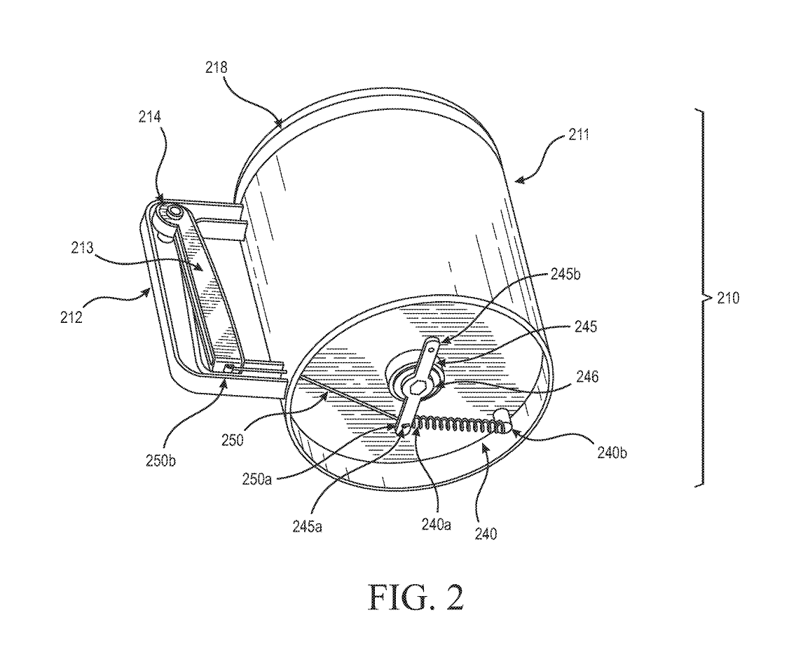

Devices 10 of the present invention can also include a trigger mechanism 13. In at least one embodiment, the trigger mechanism 13 can be hingeably connected to the handle 12 at, for example, connection points 214, 414, 514 and 614, as shown in FIGS. 2, 4, 5 and 6, respectively.

With reference to FIG. 2, portions of a device 210 according to at least one embodiment of the present invention is illustrated therein. The device 210 can include a container 211, having a handle 212. The handle 212 of the device 210 of FIG. 2 contains features that are substantially similar with or identical to features corresponding to the handle 12 of the device 10 of FIG. 1.

The device 210 of FIG. 2 also includes a rim portion 218 corresponding to an opening area adapted for receiving the animal's paw (not illustrated in FIG. 2). The rim portion 218 of the device 210 of FIG. 2 contains features that are substantially similar or identical to features corresponding to rim portion 18 of the device 10 of FIG. 1.

The device 210 can also include a trigger mechanism 213 hingeably connected to handle 212 at, for example, a connection point 214. It will be appreciated that although the trigger mechanism 213 connection to the handle 212 is that of a hingeable connection, allowing for hinged movement, other mechanisms for connecting a trigger mechanism to a handle, or to the device as whole, can also be envisioned in the scope of the present invention.

The trigger mechanism 213 can be intended to be operable to the device 210, in that when a user actively or repeatedly engages or depresses the trigger mechanism 213, said action can effect rotational movement of a cleaning platform to clean an animal's paw, to be described in this specification, infra.

### The Inner Container

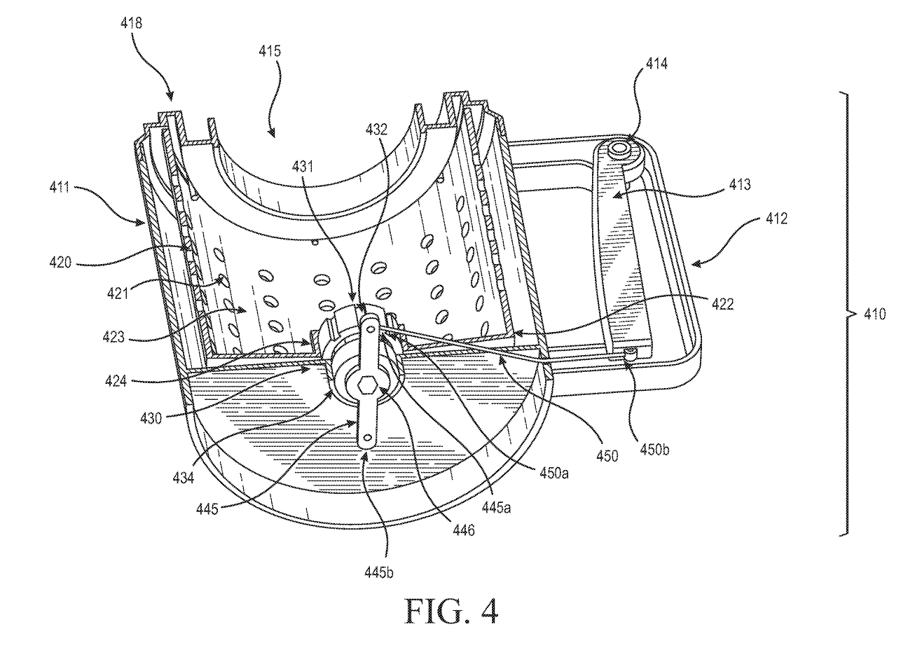

More specifically, devices of the present invention can include an inner container or cleaning platform (not illustrated in FIG. 2, but see components 420, 520, 620, 720, and 820 of FIGS. 4, 5, 6, 7, and 8, respectively). The inner container or cleaning platform can be a substantially cylindrical inner container. In at least one embodiment, the inner container can have a substantially straight shape in a longitudinal direction. Alternatively, the inner container or cleaning platform can be can have at least one curvature, ridge, and/or contour in shape in a longitudinal direction.

In certain embodiments, the inner container or cleaning platform can be removable from the device. In alternative embodiments, the inner container can be permanently affixed, attached, or molded into the main body of the device.

In at least one embodiment of the present invention, the inner container can include a plurality of through holes (not illustrated in FIG. 2, but see components 421, 521, 621, 721 and 821 of FIGS. 4, 5, 6, 7, and 8, respectively).

The plurality of through holes can be of a substantially round or circular shape, or in the shape of any polygon and/or design shape (e.g., hearts, stars, spades) as desired. In at least one embodiment, the plurality of through holes can be of a substantially uniform shape and size throughout the device. In alternate embodiments, the plurality of through holes can be of varying shape and/or sizes.

The plurality of through holes allow for a user to add a cleaning agent or cleaning fluid to the device, and also allow for circulation of said cleaning agent or cleaning fluid throughout the device when cleaning an animal's paw. The type of cleaning agent or cleaning fluid is not particularly limited, and can include water, shampoo, conditioner, veterinarian or doctor approved cleaning agents, medicated treatment fluids, flea, tick and/or parasite treatments, moisturizing solutions, disease prevention solutions, diluted solutions and fluids, and combinations thereof. In embodiments, the cleaning fluid can be added, for example, through the opening area of the device.

In at least one embodiment, a plurality of cleaning elements or scrubbing elements can be provided, extending radially inward from an inner wall of the inner container (the inner wall of the inner container is not illustrated in FIG. 2, but see components 423, 523, 723 and 823 of FIGS. 4, 5, 7, and 8, respectively).

Suitable cleaning elements or scrubbing elements for the present invention include, but are not limited to, any one of brushes, bristles, sponges, pads, and/or exfoliating surfaces, and combinations thereof. The cleaning or scrubbing elements can be made from synthetic, natural, and/or organic materials, and combinations thereof.

In at least one embodiment, the cleaning or scrubbing elements can be removable from the device. This allows for a user to replace and/or remove and clean said cleaning elements. In at least one embodiment, at least one cleaning element can be fixedly attached, or permanently attached to the device, such as to the inner wall of the inner container. The present invention can also include embodiments having both removable and permanently attached cleaning elements in the same device.

FIG. 9 depicts a cleaning element including brush 920 with a foot 925 sized larger than a hole 930 of inner container 923 where the scrubbing elements extends through hole 930 towards the inner container 923.

In at least one embodiment, the cleaning elements can be of substantially the same type and/or substantially the same shape and/or substantially the same size within the same device. Alternatively, embodiments of the present invention can include devices having varying sized cleaning elements, and/or cleaning elements of varying shape, and/or cleaning elements of varying type, in the same device. Within variations of type, shape, and/or size can also be, in cases where it is desired, variations in removability to the device.

For example, at least one device of the present invention can have a plurality of bristles extending radially inward in the inner container of the device. The plurality of bristles can all be of substantially the same size, and the plurality of bristles can all be permanently affixed or attached to the device.

Alternatively, at least one device of the present invention can have cleaning elements which include both bristles, cloth, and sponge-like materials. At least some of the sponge-like materials can be removable from the device, and the sponge-like materials are all of varying thickness and length within the same device; and the bristles are permanently or fixedly attached to the device.

### Rotational Movement

With regard to rotational movement, as mentioned briefly above in conjunction with the trigger mechanism 213, devices 210 of the present invention can also include a rotational axle (not illustrated in FIG. 2, but see components 430, 530, 730 and 830 of FIGS. 4, 5, 7 and 8, respectively). In at least one embodiment, a base of the inner container (not illustrated in FIG. 2, but see components 422, 522, 722 and 822 of FIGS. 4, 5, 7 and 8, respectively) can be in operable communication with the rotational axle.

In at least one embodiment, the rotational axle can also be in operable communication with the trigger mechanism 213 such that depression, or continued pressure and release of the trigger mechanism 213 effects rotational movement of the inner container. Put differently, with regard to the device 210 of FIG. 2, by continually depressing and releasing the trigger mechanism 213, and because of the operable communication of the rotational axle with both the trigger mechanism 213 and the inner container, depression and release of the trigger mechanism can cause the inner container and, as a direct result, the cleaning elements extending radially inward from an inner wall of the inner container, to engage in rotational movement.

In at least one embodiment of the present invention, the rotational movement can include movement in a substantially clockwise and counter-clockwise direction. For example, with regard to the device 210 of FIG. 2, depression of the trigger mechanism 213 can cause the inner container and, as a direct result, the cleaning elements extending radially inward from an inner wall of the inner container, to move in a clockwise and counter-clockwise direction with each depression and release of the trigger mechanism 213.

Put differently, in at least one device embodiment of the present invention, the inner container having a plurality of cleaning elements extending radially inward therefrom, can be operably associated with a rotational axle or shaft, said rotational axle configured to rotationally guide the inner container to engage in rotational movement within the device. As a result, an animal, paws, can be effectively and thoroughly cleaned by devices of the present invention, which overcome difficulties innate with the anatomy of different types, species and sizes of animals.

Referring back to rotational movement, in at least one embodiment of the present invention, the rotational movement can include movement in a substantially vertical direction relative to the rotational axle of the device. In at least one embodiment, the rotational movement can be in a circular motion, similar to a centrifugal device or the spin cycle of a washing machine. At least one embodiment of the present invention can be configured to engage in multiple different types of directions and/or degrees of rotational movement.

In cases where it is desired, certain embodiments of the present invention can also include a switch (not illustrated), operable change a direction and/or a degree of rotation within the device.

Operable Communication with the Rotational Axle and Other Operable Connections within the Device

Referring back to FIG. 2, at least one device 210 of the present invention can include a spring 240 having two ends, 240a and 240b. The spring 240 can be operably attached to the rotational axle at one end of the spring 240a, and operably attached to an inner wall of the inner container at an opposite end of the spring 240b. In embodiments, the spring can be configured to collect and release tensional energy as, for example, the trigger mechanism 212 of the device is engaged. It will be appreciated that other mechanisms can be present in embodiments of the present invention to effect rotational movement, aside from a trigger mechanism.

Embodiments of the present invention can also include a lever 245 having two ends, 245a and 245b. The lever 245 can be operably connected to a base of the rotational axle at a location toward a center 246 of the lever 245. The spring 240 can also be operably attached to the rotational axle via a connection point at one end 245a of the lever 245.

A connecting string 250 having two ends, 250a and 250b, can also be provided, as shown in FIG. 2 in at least one embodiment of the present invention. The connecting string 250 can be attached at one end 250a to the lever 240; and attached at its opposite end 250b to the trigger mechanism 213, as shown in FIG. 2.

The connecting string 250 can be made of any strong, resilient, durable material such as nylons, polyesters, aramid, and natural and synthetic fibers, and combinations thereof. The connecting string can 250 can also be made of elastic materials in cases where it is desired.

Removability of the Inner Container from the Device

Moreover, as noted in part above, in at least one embodiment of the present invention, the inner container can be removable from the device. In at least one embodiment, the inner container can include a central opening having a raised wall, upwardly extending from a perimeter of the central opening. See components 424, 524, 724 and 824 of FIGS. 4, 5, 7, and 8, respectively.

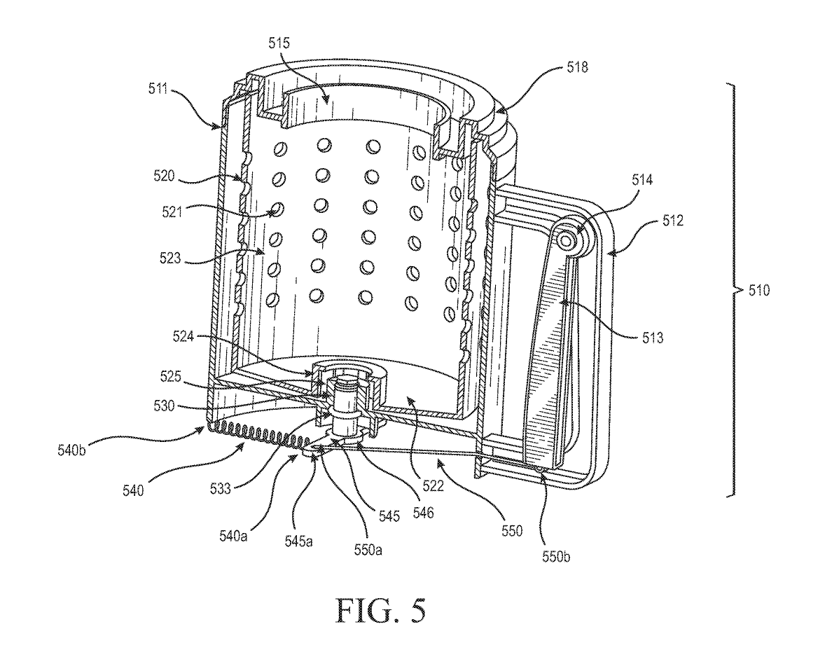

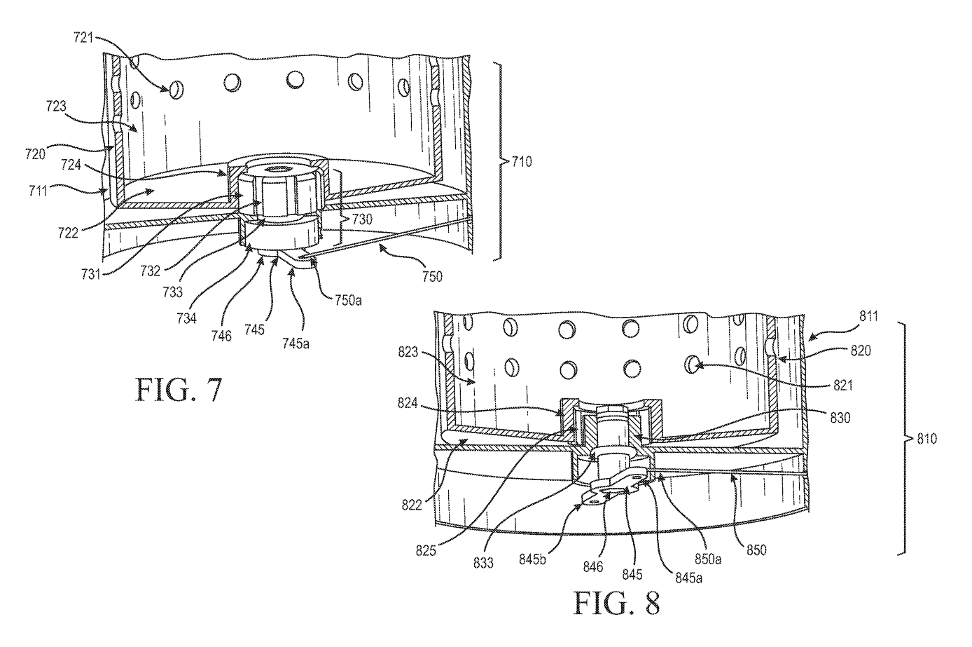

The raised wall can have a plurality of recesses, spaced throughout a perimeter of the raised wall. See components 525 and 825 of FIGS. 5 and 8, respectively. The plurality of recesses can be spaced uniformly or non-uniformly. Correspondingly, the rotational axle can include a ring portion covering at least part of an outer surface of the rotational axle. See components 431 and 731 of FIGS. 4 and 7, respectively.

The ring portion of the rotational axle, 431 and 731, can include a plurality of recess portions 432, 732, configured to connectably engage with the plurality of recesses 525, 825, of the raised wall of the base of the inner container. More specifically, in at least one embodiment, the raised wall of the inner container can be configured to fit over the ring portion of the rotational axle, where recesses in the raised wall of the inner container mate with recesses in the ring portion of the rotational axle.

FIG. 4 shows one embodiment where the inner container 420, and particularly the raised wall 424 at the base of the inner container, includes recesses which mate or fit comfortably with the recesses 432 associated with the ring portion 431 of the rotational axle 430.

In certain embodiments, the inner container can slide comfortably into or engage with the recesses of the ring portion of the rotational axle, such that the inner container can relatively easily slide in and out of the device. In alternate embodiments, the inner container can fit more snugly into the ring portion of the rotational axle.

In at least one embodiment, the ring portion of the rotational axle, and the raised wall at the base of the inner container can be threaded components, configured to threadably engage with each other. In such embodiment(s), the inner container can include a threaded center opening, capable of threadably engaging with a threaded ring portion present on the rotational axle.

In alternate embodiments, the inner container, such as the base of the inner container, can be operably connected to the rotational axle via a snap-fit mechanism, a latching mechanism, a clicking and/or locking mechanism (not illustrated). Moreover, in any one of the above embodiments, multiple locks, snapping mechanisms, latches, and/or clicking mechanism can be incorporated within the device.

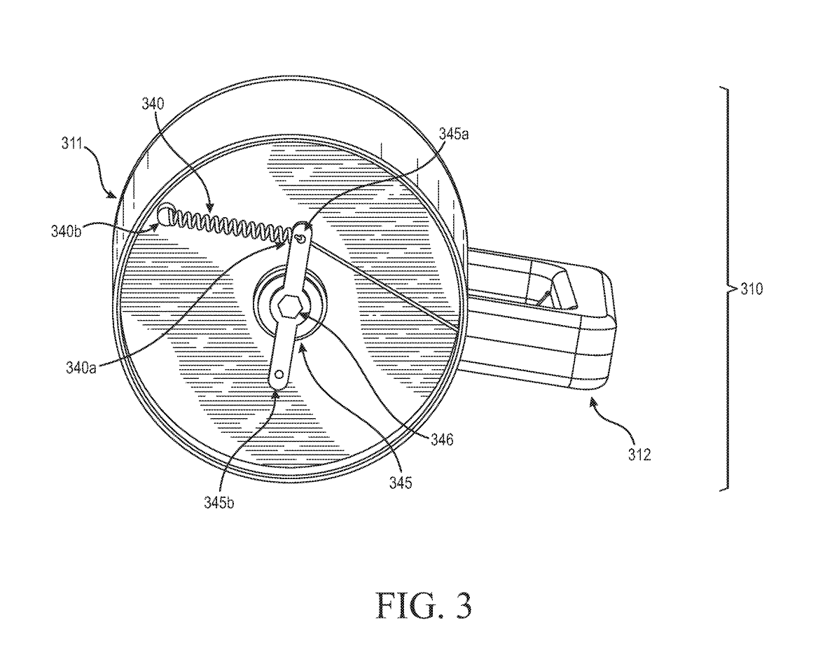

With reference to FIG. 3, a device 310 according to at least one embodiment of the present invention is illustrated therein. More specifically, FIG. 3 provides a view from the bottom of portions of said device 310. The device 310 can include a handle 312, a container 311, and a lever 345 having a central portion 346 and two ends 345a, 345b. The device 310 can also include a spring 340 having two ends 340a, 340b.

Features associated with the handle, 312, container 311, lever 345, and spring 340, and related ends, substantially correspond with, and/or are identical to, features described above with regard to the devices of FIGS. 1 and 2, 10 and 210, respectively.

With reference to FIG. 4, a device 410 according to at least one embodiment of the present invention is illustrated therein. More specifically, FIG. 4 provides a cross-sectional cutaway view of portions of the device 410 according to at least one device embodiment of the present invention.

The device 410 of FIG. 4 can include a container 411, a handle 412, a trigger mechanism 413, a hinge connection 414 of the trigger mechanism 413 to the handle 412, an opening area 415 for the insertion of the paw of an animal into the device 410, and a rim portion 418 located near the opening area 415.

The device 410 can also include an inner container 420 having a plurality of through holes 421, a base 422 of the inner container 420, an inner wall 423, and a raised wall 424 at a base 422 of the inner container 420. The device 410 can also include a rotational axle 430 having a ring portion 431, a second ring portion 434, and an o-ring present (not illustrated) provided between the ring portion 431 and the second ring potion 434.

The device 410 can also include a connecting string 450, having two ends, 450a, 450b, and a lever 445, also having two ends, 445a, 445b and a center portion 446 of said lever 445.

Features associated with the aforementioned components of the device 410 of FIG. 4 substantially correspond with, and/or are identical to, features described above with regard to the devices of FIGS. 1 and 2, 10 and 210, respectively, and features described above generally in relation to devices of the present invention as a whole, but perhaps not in relation to a specific Figure.

With reference to FIG. 5, a device 510 according to at least one embodiment of the present invention is illustrated therein. More specifically, FIG. 5 provides a cross-sectional cutaway view of portions of the device 510 according to at least one device embodiment of the present invention.

The device 510 of FIG. 5 can include a container 511, a handle 512, a trigger mechanism 513, a hinge connection 514 of the trigger mechanism 513 to the handle 512, an opening area 515 for the insertion of the paw of an animal into the device 510, and a rim portion 518 located near the opening area 515.

The device 510 can also include an inner container 520 having a plurality of through holes 521, a base 522 of the inner container 520, an inner wall 523, and a raised wall 524 at a base 522 of the inner container 520. The raised wall 524 can have a plurality of recesses 525 positioned across a perimeter of the wall 524. It will be appreciated that FIG. 5 shows a cutaway section of the device 510, and accordingly, approximately half of the inner container 520, and associated parts thereof.

The device 510 can also include a rotational axle 530 having at least one o-ring 533 provided, for example, between a ring portion and a second ring potion (not illustrated in FIG. 5, but see components 733 and 833 of FIGS. 7 and 8, respectively).

The device 510 can also include a connecting string 550, having two ends, 550a, 550b, and a lever 545, also having two ends, 545a, 545b and a center portion 546 of said lever 545.

Features associated with the aforementioned components of the device 510 of FIG. 5 substantially correspond with, and/or are identical to, features described above with regard to the devices of FIGS. 1 and 2, 10 and 210, respectively, and features described above generally in relation to devices of the present invention as a whole, but perhaps not in relation to a specific Figure.

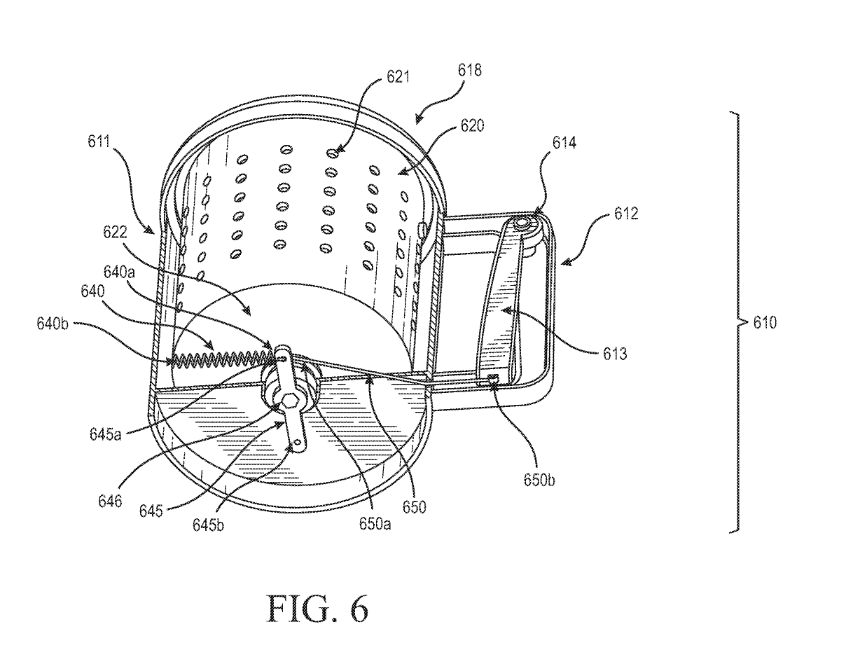

With reference to FIG. 6, a device 610 according to at least one embodiment of the present invention is illustrated therein. More specifically, FIG. 6 provides a cross-sectional cutaway view of portions of the device 610 according to at least one device embodiment of the present invention.

The device 610 of FIG. 6 can include a container 611, a handle 612, a trigger mechanism 613, a hinge connection 614 of the trigger mechanism 613 to the handle 612, and a rim portion 618.

The device 610 can also include an inner container 620 having a plurality of through holes 621, and a base 622 of the inner container 620. It will be appreciated that a portion of the container 611 in the device 610 of FIG. 6 is cutaway in the illustration thereof.

The device 610 can also include a connecting string 650, having two ends, 650a, 650b, and a lever 645, also having two ends, 645a, 645b and a center portion 646 of said lever 645. A spring 640 having two ends, 640a, 640b can also be provided.

Features associated with the aforementioned components of the device 610 of FIG. 6 substantially correspond with, and/or are identical to, features described above with regard to the devices of FIGS. 1 and 2, 10 and 210, respectively, and features described above generally in relation to devices of the present invention as a whole, but perhaps not in relation to a specific Figure as illustrated herein.

With reference to FIG. 7, cutaway portions of a device 710 according to at least one embodiment of the present invention is illustrated therein. It will be appreciated that FIG. 7 places visual emphasis on a cutaway portion of the inner bottom portion of the device 710, particularly with regard to parts associated with the rotational axle 730.

The rotational axle 730 can include a ring portion 731 having a plurality of recesses 732 positioned across a perimeter of the ring portion 731. The recesses 732 can be of uniform shape, size, and/or uniformly spaced apart. Alternatively, the recesses 732 can be of varying shape, size, and/or spaced non-uniformly throughout a perimeter of the ring portion 731. The rotational axle can also include an o-ring 733 and a second ring portion 734.

The device 710 according to at least one embodiment of the present invention can also include a container 711 and an inner container 720 having a plurality of through holes 721, and a base 722 of the inner container 720. The inner container 720 can include a raised wall 724 provided at the base 722 of the inner container 720.

The device 710 can also include a connecting string 750, having two ends, 750a and (second end not illustrated), and a lever 745, also having two ends, 745a, 745b and a center portion 746 of said lever 745.

Features associated with the aforementioned components of the device 710 of FIG. 7 substantially correspond with, and/or are identical to, features described above with regard to the devices of FIGS. 1 and 2, 10 and 210, respectively, and features described above generally in relation to devices of the present invention as a whole, but perhaps not in relation to a specific Figure.

With reference to FIG. 8, cutaway portions of a device 810 according to at least one embodiment of the present invention is illustrated therein. It will be appreciated that FIG. 8 places visual emphasis on a cutaway portion of the inner bottom portion of the device 810, particularly with regard to parts associated with the rotational axle 830. The rotational axle 830 can include an o-ring 833 provided along a length of the axle 830.

The device 810 according to at least one embodiment of the present invention can also include a container 811 and an inner container 820 having a plurality of through holes 821, and a base 822 of the inner container 820. The inner container 820 can include a raised wall 824 provided at the base 822 of the inner container 820. The raised wall 824 can include a plurality of recesses 825.

The device 810 can also include a connecting string 850, having two ends, 850a and (second end not illustrated), and a lever 845, also having two ends, 845a, 845b and a center portion 846 of said lever 845.

Features associated with the aforementioned components of the device 810 of FIG. 8 substantially correspond with, and/or are identical to, features described above with regard to the devices of FIGS. 1 and 2, 10 and 210, respectively, and features described above generally in relation to devices of the present invention as a whole, but perhaps not in relation to a specific Figure.

### Actuating Mechanism(s)

Devices of the present invention can also include an actuating mechanism connected to, and in operable communication with the device. More specifically, in such embodiments, devices of the present invention can include a rotating axle, similar to and/or identical with the rotating axle describe above, that is in operable communication with the actuating mechanism such that engagement of the actuating mechanism effects rotational movement of the inner container, similar to as described above.

In at least one embodiment, the actuating mechanism can include a wind-up mechanism. More specifically, in devices of the present invention having a wind-up actuating mechanism, a user can wind up the wind-up mechanism, and upon release, the device will engage in rotational movement for as long as the portion that was wound up, per se, takes to unwind. A user can repeatedly wind up the wind-up actuating mechanism to repeat rotational movement of the device.

In at least one embodiment, the actuating mechanism can include an electrically powered mechanism. More specifically, in at least one embodiment of the present invention, devices can include a battery compartment and an electric motor operably connected to the rotational axle. In such embodiment, the actuating mechanism can include a power button, configured to activate the electric motor and effect rotational movement of the device, such as rotational movement of the inner container. The battery compartment can be present in a separately sealed compartment of the device, such as toward the bottom of the device. In such cases, the battery compartment can be a water-proof compartment, such that water cannot enter the battery compartment. This can be especially significant as users may utilize cleaning fluid or cleaning agents in conjunction with the device, as described above.

In at least one embodiment, devices of the present invention can include a timing mechanism, configured to activate, for example, the electric motor for a predetermined amount of time. In such electrically powered mechanisms, a safety mechanism can also be added to prevent unintended or unwanted use and operation of the device.

In any one of the above embodiments of the present invention, an animal enhancer may be embedded within or coated on the base material of any portion of the device, such as the base material of the container and/or handle, etc., to attract the attention of the animal to the device, produce a calming effect to ease any nerves or anxiety that the animal may have during the paw cleaning process, and to prolong the animals interest with the device even after the animal's paw has been inserted into the device. The animal enhancer may be any substance that generates attraction to the device, or causes the animal to experience a calming effect.

In embodiments, the animal enhancer may be made from meat, seafood, or poultry broth concentrate or spray-dried powder, hydrolyzed proteins, yeast and/or yeast extract, liver, ham bone scent, or any combination of such ingredients, among others. The animal enhancer may also be tailored to the breed, specie and/or type of animal for which the device is intended to be used. For example, in the case of felines, the animal enhancer may contain catnip or other similar ingredients which are specifically favored by felines over other species of animal.

Moreover, it will be appreciated that in any one of the above embodiments of the present invention, the device can be configured such that the container of the device is substantially leakproof. Although it will be understood that fluid or material may exit through the opening area of the device, once fluid or material is added to the device (through, for example, the opening area), no leakage should occur during use of the device.

In cases where it is desired, the device of the present invention can be coated with an additional film or layer to enhance said leakproof feature.

Embodiments of the present invention also include methods for cleaning an animal's paws. Methods for cleaning an animal's paw can include a step of adding a cleaning solution into the container of devices described herein. An animal's paw can be inserted into the device, such as through the opening area of the device. In cases where the device includes a trigger mechanism, methods can include engaging or actively depressing the trigger mechanism, repeatedly, to effect rotational movement of the inner container of the device. The animal's paw can be removed from the device once cleaning is complete.

Animals of the present invention include, but are not limited to, pets and farm animals, such as horses, sheep, lamb, and goats. Animals can also include any tamed or domesticated animals found in zoos, public and private exhibits, educational institutions, government facilities, military institutions, and work animals.

As used herein, “pet” refers to an animal that is tamed or domesticated and kept for pleasure as a companion. Illustrative examples of suitable pets include pet breeds that have a paw.

The corresponding structures, materials, acts, and equivalents of all means plus function elements in the claims below are intended to include any structure, or material, for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments.

The terminology used herein was chosen to best explain the principles of the embodiments, the practical application or technical improvement over technologies found in the marketplace, or to enable others of ordinary skill in the art to understand the embodiments disclosed herein.

It will be appreciated that not all of the features, components and/or activities described above in the general detailed description in relation to embodiments of the present disclosure or the examples are required, that a portion of a specific feature, component and/or activity may not be required, and that one or more further features, components and/or activities may be required, added or performed in addition to those described. Still further, the orders in which activities are listed are not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention.

Further, references to values stated in ranges include each and every value within that range, and the endpoints of said ranges. Thus, to the maximum extent allowed by law, the scope of the present invention is to be determined by the broadest permissible interpretation of the following claims and their equivalents, and shall not be restricted or limited by the foregoing detailed description.

What is claimed is:

1. A device for cleaning an animal's paw comprising:
a container comprising a handle and an opening area adapted for receiving the animal's paw;
a flexible insertion piece substantially covering the opening area, said flexible insertion piece comprising a plurality of radially recessed portions recessed in a direction insertion of the paw;
a trigger mechanism hingeably connected to the handle;
an inner container comprising a plurality of through holes, a plurality of cleaning elements extending radially inward from an inner wall of said inner container, and a base,
a rotational axle in operable communication with the base and in operable communication with said trigger mechanism such that depression of said trigger mechanism effects rotational movement of the inner container.

2. The device of claim 1, wherein the rotational movement comprises movement in a substantially clockwise and counter-clockwise direction relative to the rotational axle.

3. The device of claim 1, wherein the rotational movement comprises movement in a substantially vertical direction relative to the rotational axle.

4. The device of claim 1, further comprising a switching mechanism for changing a direction of rotation.

5. The device of claim 1, further comprising a spring operably attached to the rotational axle at one end of the spring, and operably attached to an inner wall of the inner container at an opposite end of the spring, wherein the spring is configured to collect and release energy as the trigger mechanism of the device is engaged.

6. The device of claim 5, further comprising a lever operably connected to a base of the rotational axle at a location toward a center of the lever, and
wherein the spring is operably attached to the rotational axle via a connection point at one end of the lever.

7. The device of claim 6, further comprising a connecting string attached at one end to the lever, and attached at an opposite end to the trigger mechanism.

8. The device of claim 1, wherein the plurality of cleaning elements includes at least one member selected from the group consisting of brushes, bristles, sponges, pads, and scrubbing elements.

9. The device of claim 1, wherein the plurality of cleaning elements are at least one of
configured to be removable from the inner wall of the inner container;
different sizes throughout the device;
fixedly attached to the inner container.

10. The device of claim 1, wherein the base of the inner container comprises a central opening having a raised wall upwardly extending from a perimeter of the central opening, said raised wall comprising a plurality of recesses, and
wherein the rotational axle includes a ring portion covering at least a part of an outer surface of the rotational axle, said ring potion comprising a plurality of recesses configured to connectably engage with the plurality of recesses of the raised wall of the base of the inner container.

11. The device of claim 1, wherein the base of the inner container is operably connected to the rotational axle via a snap-fit mechanism.

12. The device of claim 1, wherein the base of the inner container comprises a threaded center opening, and
wherein the rotational axle includes a threaded ring portion covering at least part of the outer surface of the axle, said threaded ring potion configured to threadably engage with the threaded center opening associated with the base of the inner container.

13. The device of claim 1, further comprising a rim portion attached on one side to the opening area and removably attached on an opposite side to the flexible insertion piece.

14. The device of claim 1, wherein the inner container is at least one of substantially straight in a longitudinal direction; and
comprises at least one curvature in a longitudinal direction.

15. The device of claim 1, wherein the device is
comprised of a material embedded with an animal enhancer, said animal enhancer comprising any substance that generates attraction from the animal to the device; or
coated with an animal enhancer, said animal enhancer comprising any substance that generates attraction from the animal to the device.

16. A method for cleaning an animal's paw comprising:
adding a cleaning solution into the device of claim 1;
inserting an animal's paw into the device of claim 1 through the opening area;
engaging the trigger mechanism to effect rotational movement; and
removing the animal's paw from the device.

17. A device for cleaning an animal's paw comprising:
a container including a handle and an opening area adapted for receiving the animal's paw;
a flexible insertion piece attached to and substantially covering the opening area, said flexible insertion piece including a plurality of radially recessed portions recessed in a direction insertion of the paw;
an actuating mechanism connected to and in operable communication with the device;
an inner container comprising a plurality of through holes, a plurality of cleaning elements extending radially inward from an inner wall of the inner container, and a base;
a rotational axle operably connected to the base of the inner container and operably connected to the actuating mechanism such that engagement of the actuating mechanism effects rotational movement of the inner container.

18. The device of claim 17, wherein the actuating mechanism comprises a wind-up mechanism.

19. The device of claim 17, further comprising a battery compartment and an electric motor operably connected to the rotational axle, and wherein the actuating mechanism comprises a power button configured to activate the electric motor and effect rotational movement of the inner container.

20. The device of claim 17, wherein the base of the inner container comprises a threaded center opening, and
wherein the rotational axle includes a threaded ring portion covering at least a part of an outer surface of the rotational axle, the threaded ring potion configured to threadably engage with the threaded center opening of the base of the inner container.
